(19) United States
(12) Patent Application Publication
(10) Pub. No.: US 2015/0363869 A1
(43) Pub. Date: Dec. 17, 2015

(54) METHOD OF ACTIVATING OTHER FUNCTION OF APPLICATION AND MOBILE COMMUNICATION DEVICE, SERVER APPLY TO THE METHOD

(71) Applicant: NINETEN TECHNOLOGY CO., LTD., Taipei City (TW)

(72) Inventor: Fu-Ming WANG, Taipei City (TW)

(21) Appl. No.: 14/732,402

(22) Filed: Jun. 5, 2015

(30) Foreign Application Priority Data
Jun. 17, 2014 (TW) 103120928

(51) Int. Cl. G06Q 30/06; H04M 1/725

(52) U.S. Cl. CPC G06Q 30/0635; H04M 1/72522

(57) ABSTRACT

A method of activating an order function of an application is provided. The application is installed in a mobile communication device and includes a display function and an inactivated order function. The method includes following steps of: receiving an input by the mobile communication device to send a request data of activating the order function; sending a validation data by the mobile communication device; receiving an authorization data by the communication device; and activating the order function of the application by the mobile communication device according to the authorization data.

### CROSS REFERENCE TO RELATED APPLICATIONS

This Non-provisional application claims priority under 35 U.S.C. §119(a) on Patent Application No(s). 103120928 filed in Taiwan, Republic of China on Jun. 17, 2014, the entire contents of which are hereby incorporated by reference.

### BACKGROUND OF THE INVENTION

1. Field of Invention

This invention relates to a method of activating other function of the application and a mobile communication device and server corresponding to the method.

2. Related Art

With the progress of technologies, the market unceasingly reveals various information devices, such as smart phones, tablet computers, wearable devices or the like, and this great upsurge also push forward the development of the mobile application (App) which is executed in the mobile communication device. Since the combination of the smart mobile communication device and the application brings about great convenience and versatility, many traditional commercial activities are gradually shifted to this kind of platform to effectively meet the demand from the consumer side and the seller side.

As to the commercial activity of calling a taxi, before the smart mobile communication device has been popularized, the passenger must make a phone call to the taxi service station so that the taxi service station can communicate with the taxi by the wireless communication device to call a taxi coming to the passenger. Currently, there has been the application applied to the taxi calling system for the use of passengers and drivers. Moreover, as to the commercial activity of purchase, the consumers and sellers transact businesses through physical stores, TV shopping or telephone shopping before, but now through the applications which are designed specifically for the purchase, whereby the consumers and sellers can immediately exchange information and transact businesses anywhere.

However, the application still has defects. As to the commercial activity, the business transaction is done by at least two sides and each of the sides may have different requirement for the business transaction, so the function of the application needs to satisfy different demands. For example, the above-mentioned commercial activity of calling taxi is taken by the passenger (consumer side) and driver (seller side), and the desired interface of the passenger may be different from that of the driver.

Conventionally, there are two kinds of applications respectively for the consumer and seller which can be downloaded according to the role of the user, but the inconvenience will occur in the case where a customer needs to additionally download the application for the seller after transformed into the seller because of the satisfaction with the product. Besides, because the sales company hopes to encourage the seller to convince the customer of the affiliation to be a new seller, the transaction data of the new seller needs to be connected to the original seller for the bonus counting.

Accordingly, it is important to conveniently make the application execute the originally unexecuted function and make the transaction data connected with the original seller.

### SUMMARY OF THE INVENTION

An objective of the invention is to provide a method of activating other function of the application and a mobile communication device and server corresponding to the method, whereby the consumer side has no need to additionally download a different application after transformed into the seller side, and the function related to the seller side can be provided by the method of activating the application through the authorization and the method of updating the application.

To achieve the above objective, a method of activating an order function of an application according to the invention is provided. The application is installed in a mobile communication device and includes a display function and an inactivated order function. The method includes following steps of: receiving an input by the mobile communication device to send a request data of activating the order function; sending a validation data by the mobile communication device; receiving an authorization data by the communication device; and activating the order function of the application by the mobile communication device according to the authorization data.

To achieve the above objective, a mobile communication device according to the invention includes a memory unit and at least one processing unit. The memory unit stores an application which includes a plurality of instructions and has a display function and an inactivated order function. The processing unit is coupled with the memory unit and executes the instructions to have the following operations of: receiving an input by the mobile communication device to send a request data of activating the order function; sending a validation data by the mobile communication device; receiving an authorization data by the mobile communication device; and activating the order function of the application according to the authorization data.

To achieve the above objective, a method of activating the order function of the application according to the invention is provided. The application is installed in a mobile communication device and has a display function and an inactivated order function. The mobile communication device is connected with a server. The method includes the steps of: receiving a request data of activating the order function by the server; receiving a validation data by the server; and sending an authorization data to the mobile communication device according to the validation data by the server, wherein the mobile communication device activates the order function of the application according to the authorization data.

To achieve the above objective, a server according to the invention is applied to activating an order function of an application and connected with a mobile communication device, and comprises a receiving module and a transmitting module. The receiving module receives a request data of activating the order function and a validation data sent by the mobile communication device. The transmitting module sends an authorization data to the mobile communication device according to the validation data, wherein the mobile communication device activates the order function of the application according to the authorization data.

In one embodiment, the validation data is an identity data of a seller.

In one embodiment, the seller has another mobile communication device which is equipped with same application where the order function is activated.

In one embodiment, the method of activating the order function of the application further includes a step of: activating a sales bonus counting function according to the authorization data.

In one embodiment, the application has an inactivated sales bonus counting function, and the processing unit executes the instructions to have the following operation of: activating the sales bonus counting function according to the authorization data.

In one embodiment, the method of activating the order function of the application further includes the step of: sending a validation request data to the mobile communication device according to the request data of activating the order function, and the mobile communication device reacts to the validation request data to send the validation data.

In one embodiment, the transmitting module sends a validation request data to the mobile communication device according to the request data of activating the order function, and the mobile communication device reacts to the validation request data to send the validation data.

To achieve the above objective, a method of updating the application according to the invention is provided. The application is applied to a mobile communication device and includes a display function. The method includes the steps of: receiving an input by the mobile communication device to send a request data of updating the application; sending a validation data by the mobile communication device; receiving an updating data corresponding to the application by the mobile communication device; and updating the application according to the updating data by the mobile communication device, the updated application having the display function and an order function.

To achieve the above objective, a mobile communication device according to the invention includes a memory unit and at least one processing unit. The memory unit stores an application which includes a plurality of instructions and has a display function. The processing unit is coupled with the memory unit and executes the instructions to have the following operations of: receiving an input by the mobile communication device to send a request data of updating the application; sending a validation data by the mobile communication device; receiving an updating data corresponding to the application by the mobile communication device; and updating the application according to the updating data, the updated application having the display function and an order function.

To achieve the above objective, a method of updating the application according to the invention is provided. The application is installed in a mobile communication device and has a display function. The mobile communication device is connected with a server. The method includes the steps of: receiving a request data of updating the application by the server, the request data of updating the application sent by the mobile communication device according to an input; receiving a validation data by the server; and sending an updating data to the mobile communication device according to the validation data by the server, the mobile communication device updating the application according to the updating data, the updated application having the display function and an order function.

To achieve the above objective, a server applied to updating an application of a mobile communication device is provided. The server is connected with the mobile communication device and includes a receiving module and a transmitting module. The receiving module receives a request data of updating the application and a validation data sent by the mobile communication device. The transmitting module sends an updating data to the mobile communication device according to the validation data, wherein the mobile communication device updates the application according to the updating data, and the updated application has the display function and an order function.

In one embodiment, the validation data is an identity data of a seller.

In one embodiment, the seller has another mobile communication device which is equipped with the updated application.

In one embodiment, the updated application further has a sales bonus counting function.

In one embodiment, the method of updating further includes the step of: sending a validation request data to the mobile communication device by the server according to the request data of updating the application, wherein the mobile communication device reacts to the validation request data to send the validation data.

In one embodiment, the transmitting module sends a validation request data to the mobile communication device according to the request data of updating the application, and the mobile communication device reacts to the validation request data to send the validation data.

As mentioned above, in the method of activating the order function of the application and the method of updating the application of the invention, the application of the customer side has the display function instead of other functions of the non-customer side, so that the user of the customer side can intuitively operate the display function and won't be affected by the interfaces of other functions. Besides, the customer side also has no chance to directly purchase products, and therefore the company can totally handle the performance and bonus of the seller. Moreover, when the customer side hopes to be transformed into the seller side, the order function of the application just can be activated after the mobile communication device sends the request data of activating the order function and the validation data and the server provides the authorization data. Or, the application just has the order function after the mobile communication device sends the request data of updating the application and the validation data and the server provides the updating data. In other words, when the customer side hopes to be transformed into the seller side, the customer has no need to download an additional application, and the application can provide the function related to the seller side just by the method of activating the application through the authorization or the method of updating the application. Therefore, the aspiration to become a seller can be promoted and the number of the seller can be increased thereby.

Furthermore, after the mobile communication device sends the validation data, the server just can send the authorization data or updating data to the mobile communication device and then the mobile communication device can operate the order function. Since the validation data is the identity data of the original seller, the relationship between the original seller (introducer) and the new seller can be built, so that the order data of the new seller can be connected to the original seller, so as to facilitate the performance and bonus counting of the company.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of the architecture of the sales system of an embodiment of the invention;

FIGS. 2A and 2B are schematic diagrams of the graphical user interface after the sales application of the mobile communication device of the customer is activated;

FIGS. 3A and 3B are schematic diagrams of the graphical user interface after the sales application of the mobile communication device of the seller is activated;

FIG. 4 is a schematic flowchart of the method of activating the order function of the sales application of the first embodiment of the invention;

FIG. 5 is a schematic flowchart of the method of activating the order function of the sales application of the second embodiment of the invention;

FIG. 6 is a schematic diagram of the graphical user interface of the second embodiment of the invention; and

FIG. 7 is a schematic flowchart of the method of updating the sales application of the third embodiment of the invention.

### DETAILED DESCRIPTION OF THE INVENTION

The present invention will be apparent from the following detailed description, which proceeds with reference to the accompanying drawings, wherein the same references relate to the same elements.

Firstly, the method of activating order function of the mobile application (App) and the method of updating the application are illustrated by the example of the sales application, and the sales application is mainly for the use of the seller to promote the product to the customer. In application, the points of sales (POS) can be consulted. In the following embodiments, the method of activating the order function of the sales application and the method of updating the sales application will be illustrated, and the sales system using the activating and updating methods will also be illustrated.

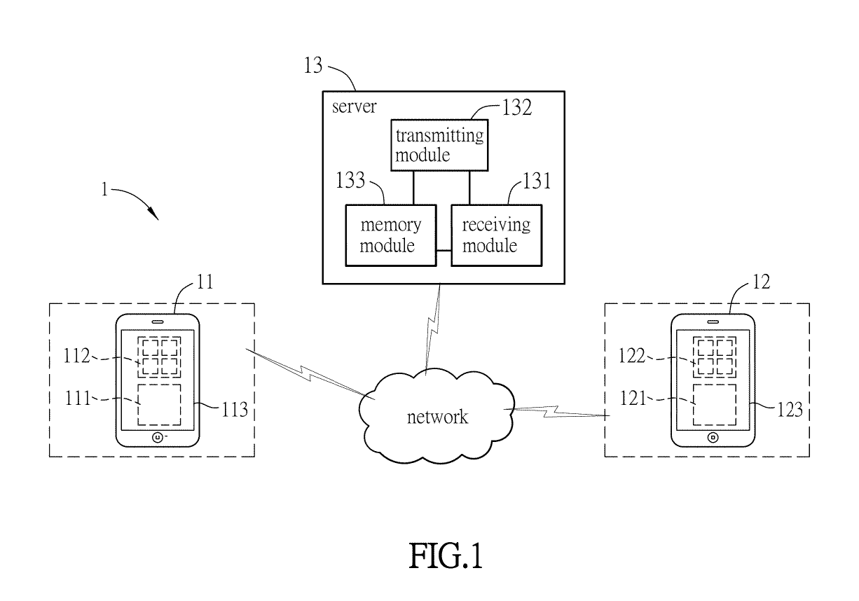

FIG. 1 is a schematic diagram of the architecture of the sales system of an embodiment of the invention. As shown in FIG. 1, the sales system 1 of this embodiment includes a customer-side mobile communication device 11, a seller-side mobile communication device 12 and a server 13. The mobile communication devices 11, 12 and the server 13 are connected with each other by the network. Physically, the manner of the date transmission among the mobile communication devices 11, 12 and the server 13 will be varied according to the type of hardware architectures, and can be accomplished by, for example, 3G, Wi-Fi or 4G LTE technology. For example, the server 13 can be connected with the Internet in a wired manner, and can implement the data transmission with the customer-side mobile communication device 11 or the seller-side mobile communication device 12 through a Wi-Fi data transmission element and Internet.

The mobile communication device 11 is operated by a consumer customer and the mobile communication device 12 is operated by a seller. The mobile communication devices 11, 12 are, for example but not limited to, smart mobile phones (such as smart phones), wearable smart household appliances (such as smart watches or smart bracelets), tablet computers, PDAs, wearable devices, smart household appliances or other electronic devices. Accordingly, in a viewpoint of the architecture, the sales system 1 of this embodiment is at least composed of the customers operating the mobile communication device 11, the sellers operating the mobile communication device 12 and the enterprises maintaining the system (the server 13). Of course, the system maintaining enterprise and the sellers can belong to the same company.

As shown in FIG. 1, each of the customer-side mobile communication device 11 and the seller-side mobile communication device 12 can include a memory unit, one or more processing units and a touch display unit. By taking the mobile communication device 11 as an example, the memory unit 111 thereof can be a hard disc storing a plurality of programs and instructions of the sales application, one or more processing units 112 thereof can form a chip set coupled with the memory unit 111, and the touch display unit 113 thereof is a touch screen. When the customer-side mobile communication device 11 is operated or used, the processing unit 112 will execute the instructions in the memory unit 111 to generate the corresponding operation.

In this embodiment, the customer-side and seller-side mobile communication devices 11, 12 are both smart mobile phones, and the seller-side mobile communication device 12 is equipped with the sales application in advance to show the product display function so as to help the seller reveal the product to the potential customer for the product promotion. If the seller-side mobile communication device 12 is a tablet computer, the similar effect also can be achieved. Therefore, for example, before visiting the customer, the seller needs to install the sales application to the own mobile communication device 12.

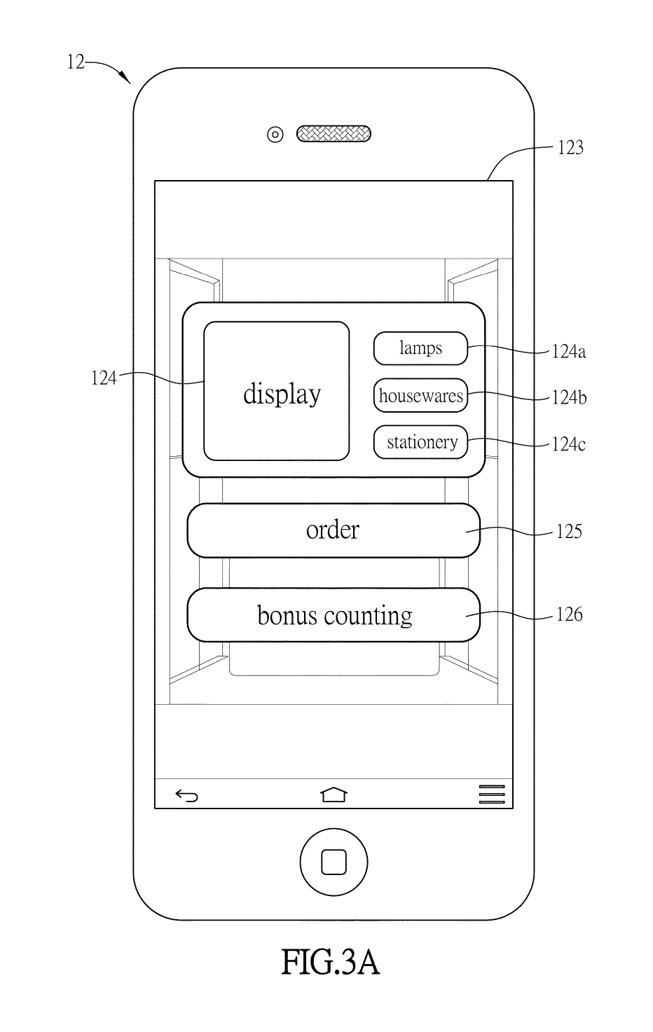

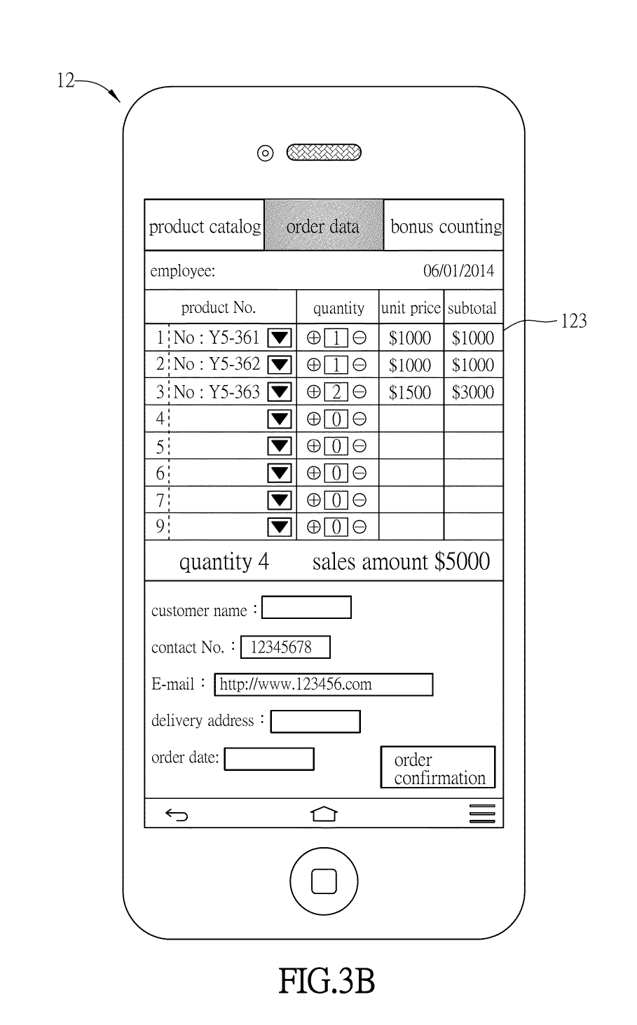

The installed sales application can be stored in the memory unit 121. The sales application includes a plurality of instructions, which include the instructions related to the display function and the instructions related to the order function, and the processing unit 122 will execute the instructions to generate the corresponding operation (referring to FIG. 3). The display function can display the e-catalog or propaganda literature, which can be carried by the sales application so as to be read from the memory unit 121 or stored in the server 13 and can be obtained by the downloading. When the customer wants to make a purchase, the seller can directly operate the mobile communication device 12 to order the product through the order function of the sales application. Then, the mobile communication device 12 will send an order data, which includes the identity of the seller and the ordered product for example, to the server 13, and the company owning the server 13, i.e. the company producing the product, can count the performance or bonus of the seller accordingly.

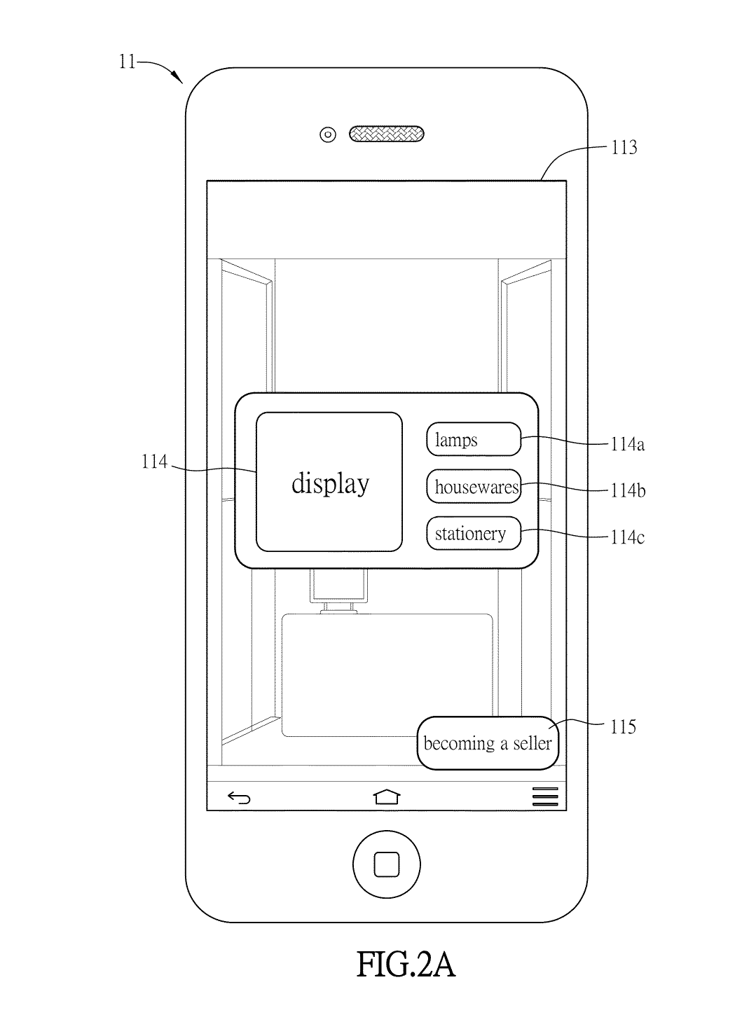

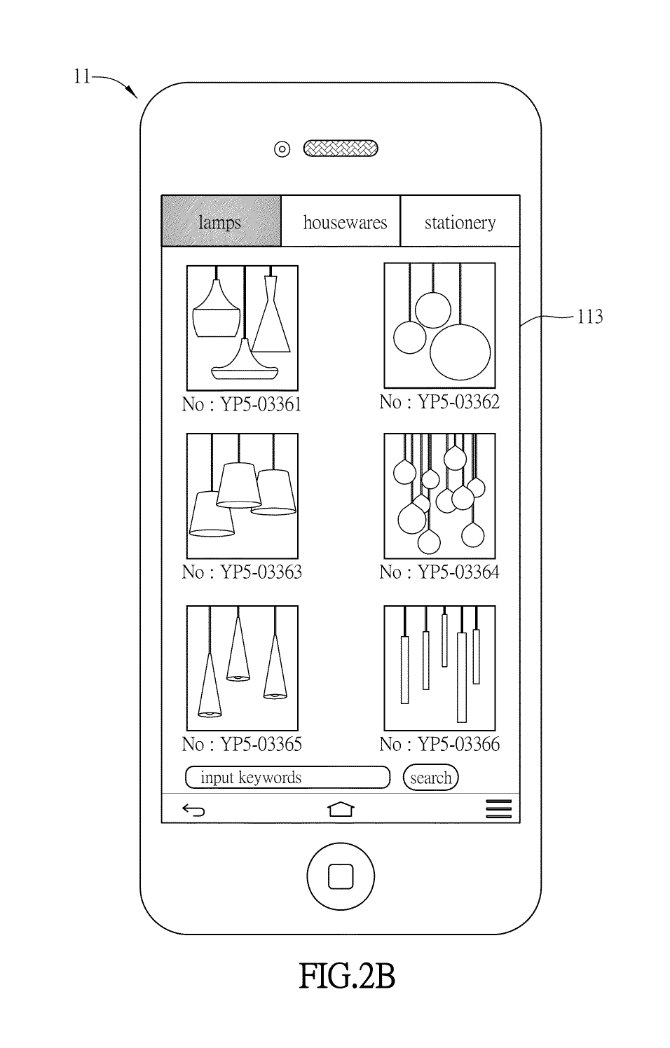

However, the customer mostly can't decide the purchase immediately before the sufficient consideration during the promotion of the product. In this case, for making the customer appreciate the product more and longer, the seller may, of his own accord or at the customer's request, help the customer to download the application the same as the seller's through the customer's mobile communication device 11. Because just making the customer feel more appreciation of the product, the application downloaded by the customer just has the display function instead of the order function. FIGS. 2A and 2B are schematic diagrams of the graphical user interface after the sales application of the mobile communication device 11 of the customer is activated. As shown in FIG. 2A, the interface has a functional icon 114 for the display, and furthermore, the different kinds of the products can be displayed by different functional icons 114a, 114b, 114c. When some functional icon 114, such as the functional icon 114a of the lamps, is touched, the content can be shown as the e-catalog in FIG. 2B. Because the application is without the order function, the customer needs to ask the seller to purchase the product when deciding to buy the product. Thereby, the company can handle the performance or bonus.

The common case is that the customer wants to promote the product and to be transformed into the seller from the customer after a period of time buying the product because of the satisfaction at the product. In this case, however, as shown in FIG. 2A, the sales application of the customer is without the order function, so that the customer needs the method of activating the order function of the sales application or the method of updating the sales application to equip the own mobile communication device 11 with the order function, just like the seller.

FIGS. 3A and 3B are schematic diagrams of the graphical user interface after the sales application of the mobile communication device of the seller is activated, and also the schematic diagrams of the graphical user interface after the order function of the sales application of the mobile communication device of the original customer is activated or after the sales application is updated (in contrast with FIGS. 2A and 2B). As shown in FIG. 3A, when the order function of the sales application is activated or the sales application is updated, the functional icon 125 for the order can be shown. When the functional icon 125 is touched, the interface of the operation of the order function in FIG. 3B can be shown. In other words, the mobile communication devices 11, 12 can download the same sales application for the installation, and then the mobile communication device 11 can acquire the order function by the method of activating the order function or the method of updating the sales application. To be noted, after installing the sales application, the seller also can activate the order function by the same or similar method.

In one embodiment, the sales application stored in the server 13 has the complete display function and order function and the related operation instructions, but just can use the display function rather than the order function before the activation. Meanwhile, the graphical user interface is shown as FIG. 2A.

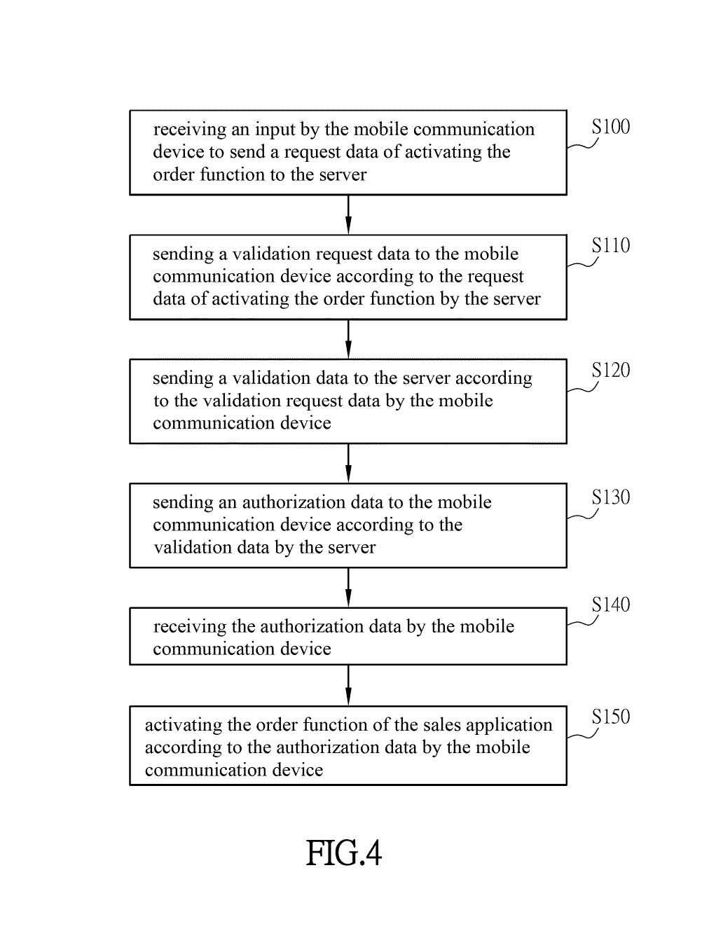

FIG. 4 is a schematic flowchart of the method of activating the order function of the sales application of the first embodiment of the invention. As shown in FIG. 4, the method of activating the order function of the sales application includes the steps of: receiving an input by the mobile communication device to send a request data of activating the order function to the server (step S100); sending a validation request data to the mobile communication device according to the request data of activating the order function by the server (step S110); sending a validation data to the server according to the validation request data by the mobile communication device (step S120); sending an authorization data to the mobile communication device according to the validation data by the server (step S130); receiving the authorization data by the mobile communication device (step S140); and activating the order function of the sales application according to the authorization data by the mobile communication device (step S150).

As shown in FIGS. 2A and 4, in the step S100, the graphical user interface will show a functional icon 115 such as “becoming a seller” before the order function of the sales application is activated, and the customer can do an input such as touching the functional icon 115 on the mobile communication device 11 to induce an input event. As a supplement to the input, when the customer executes a physical input action such as a click, touch or press (but this invention is not limited thereto) on the mobile communication device 11, the physical action will be converted into signal through the firmware of the mobile communication device 11 of the customer side and then converted into the instruction through the input module driver. The instruction is executed by the processing unit 112 to generate the corresponding operation. In this embodiment, the processing unit 112 will, in response to the input action that is represented by touching the functional icon 115 of “becoming a seller”, operate to generate a request data of activating the order function and send it to the server 13. To be noted, the so-called input in the following illustration can be comprehended according to the above-mentioned principle and the related description will be omitted therefore.

As shown in FIG. 1, the server 13 of this embodiment includes a receiving module 131 and a transmitting module 132. When the receiving module 131 of the server 13 receives the request data of activating the order function, the sever 13 can react to this request data to recognize the data transmission source and generate the validation request data. Then, the server 13 will send a validation request data to the mobile communication device 11 (step S110). Then, after receiving the validation request data, the mobile communication device 12 can react to the validation request data to send a validation data to the server 13 (step S120), and the server 13 will execute the subsequent operation after receiving the validation data. The validation data of this embodiment is the identity data of the seller, so the customer needs to provide the identity data of the seller promoting the product to the customer in an in-advance storing manner or an immediate input manner. In other words, the customer needs to provide the identity data of the introducer as the validation data, and the introducer should be the seller who has ever promoted the product. Thereby, the company of the product can effectively handle the performance and bonus of the seller.

In one embodiment to achieve the above mention, in the step S120, after the mobile communication device 11 receives the validation request data, the touch display unit 113 can display the region where the introducer data needs to be inputted, so that the customer can input the identity data of the seller in a manual manner and the identity data can server as the validation data to be sent to the server 13.

Then, the server 13 can send an authorization data to the mobile communication device according to the validation data (step S130). In this embodiment, the server 13 further includes a memory module 133, and the memory module 133 stores a database that stores the identity data of each seller. After receiving the validation data, the server 13 can determine whether the validation data conforms to identity data of one of the sellers in the memory module 133 or not. If the result is yes, the server 13 can send the authorization data to the mobile communication device 11, and further, the server 13 can mark the seller as the introducer. Therefore, when the customer becomes a new seller, the transaction data thereof can be connected to the introducer (the original seller) for the performance counting of the seller, and the related illustration will be presented below.

Then, after receiving the authorization data (step S140), the mobile communication device 11 can activate the order function of the sales application according to the authorization data (step S150). Physically, in one embodiment, the authorization data is the key which can activate the order function. The server 13 reacts to the serial number of the installed sales application to generate a key as the authorization data, and the server 13 can send the authorization data to the mobile communication device 11 in a short message manner. Thus, the mobile communication device 11 can obtain the key for activating the order function, and the customer can input the key in a manual manner. The sales application also has the procedure of validating the key, and the processing unit 113 executes the procedure of validating the key.

In another embodiment, the authorization data contains the key for activating the order function and the instruction for inputting the key, so when the mobile communication device 11 receives the authorization data, the touch display unit 113 can display the functional icon for activating the order function and the customer can directly touch the functional icon, so that the processing unit 112 executes the instruction of inputting the key activating the order function so as to execute the procedure of validating the key.

After the validation, as shown in FIG. 3A, the graphical user interface of the sales application displays the functional icon 125 for the order and the graphical user interface shown by the sales application is equipped with the order function, so that the customer can execute the operation of the order function so as to purchase the product on behalf of other new customers after transformed into the seller. As shown in FIG. 3B, the graphical user interface of the order function is similar to the interface of a hand-held cash register equipment or cash register system, and can be a simple version of the interface of the sales system, but this invention is not limited thereto.

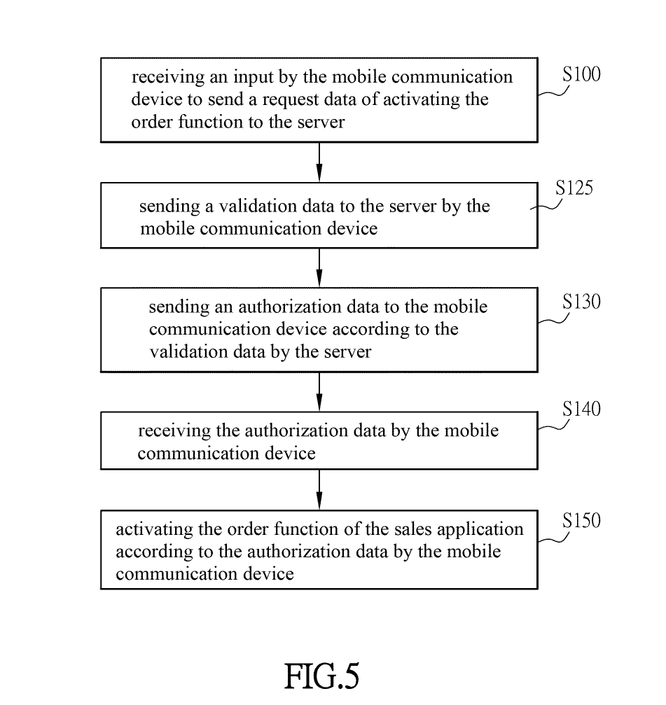

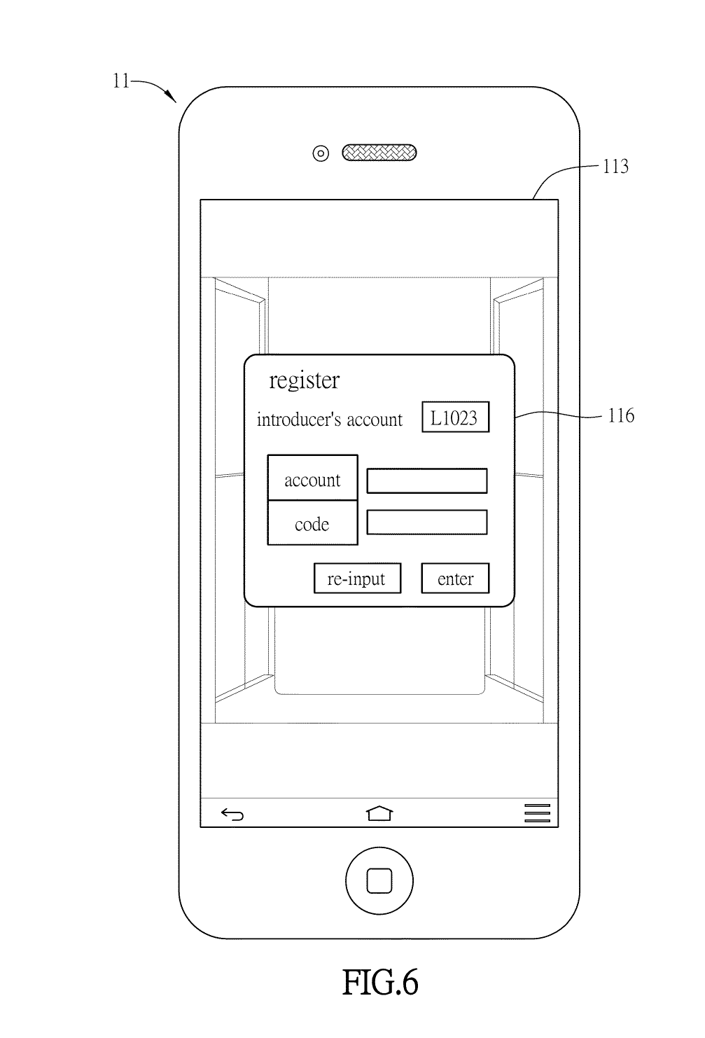

In other embodiments, the request data of activating the order function and the validation data can be both sent to the server 13. FIG. 5 is a schematic flowchart of the method of activating the order function of the sales application of the second embodiment of the invention, and FIG. 6 is a schematic diagram of the graphical user interface of the second embodiment of the invention. As shown in FIGS. 5 and 6, after equipped with the sales application, the mobile communication device 11 of the customer side can show the register window 116 so that the customer can input the introducer's account and the register customer's account and code. For example, the introducer's account can be L1023 shown in FIG. 6, which represents the identity data of the original seller as the validation data. In other embodiments, the basic data of the customer, such as the real name, contact number and delivery address, can be further inputted. Therefore, while the request data of activating the order function is sent to the server 13 (step S100), the validation data can be sent out (step S125); or the request data of activating the order function sent by the mobile communication device 11 can contain the identity data of the seller. In the above both cases, the steps S100 and S125 can be executed at the same time. In this embodiment, the server 13 has no need to send the validation request data and to ask the mobile communication device 11 to send the validation data, and therefore not only the operation of the customer to manually input the identity data (validation data) of the seller can be saved but also the operation of the server 13 to query the validation request data can be saved. The subsequent operations can be comprehended by referring to the first embodiment, and therefore the related illustration is omitted here for conciseness.

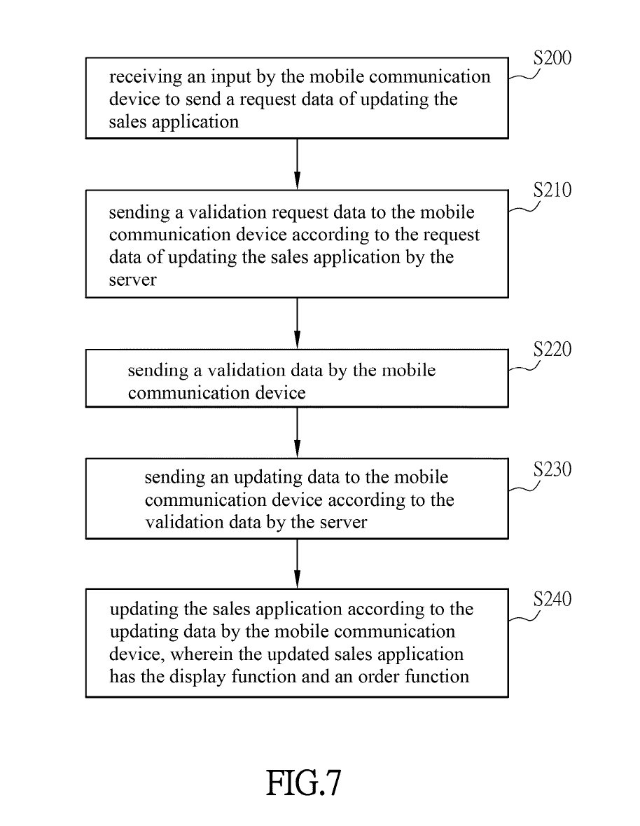

In the third embodiment of the invention, the sales application downloaded by the mobile communication device 11 of the customer side just has the operation instructions related to the display function, and the operation instructions related to the order function need to be added by the method of updating the sales application to activate the order function. As shown in FIG. 7, the method of updating the sales application of this embodiment includes the steps of: receiving an input by the mobile communication device to send a request data of updating the sales application (step S200); sending a validation request data to the mobile communication device according to the request data of updating the sales application by the server (step S210); sending a validation data by the mobile communication device (step S220); sending an updating data to the mobile communication device according to the validation data by the server (step S230); and updating the sales application according to the updating data by the mobile communication device, wherein the updated sales application has the display function and an order function (step S240).

As shown in FIGS. 1, 2A, 7, the customer also can do a physical action such as a click, touch or press on the touch display unit 113 of the mobile communication device 11. In this embodiment, when the functional icon 115 of “becoming a seller” as shown in FIG. 2A is touched, the processing unit 112 will operate to send the request data of updating the sales application (step S200) to the server 13. Then, the server 13 can send the validation request data to the mobile communication device 11 according to the request data of updating the sales application (step S210), and the mobile communication device 11 can send the validation data correspondingly (step S220). In this embodiment, the validation data is also the identity data of the seller. The operations of the steps S200˜S220 can be comprehended by referring to the steps S100˜S120 of the first embodiment or the steps S100˜S125 of the second embodiment, and therefore the related illustration is omitted here for conciseness.

In the step S230, the server 13 can send an updating data to the mobile communication device 11 according to the validation data. Likewise, the above-mentioned “according to the validation data” means the server 13 can determine whether the validation data conforms to the identity data of one of the sellers in the memory module 133 after receiving the validation data. If the result is yes, the server 13 sends the updating data to the mobile communication device 11. The updating data contains the data related to the order function, such as the user interface and the operation instructions, and can further contain the instruction of deleting the data related to touching the functional icon 115 of “becoming a seller”. When the mobile communication device 11 receives the updating data, the processing unit 112 updates the sales application according to the updating data. Physically, the processing unit 112 can delete the user interface and operation instructions related to touching the functional icon 115 of “becoming a seller” of the sales application, and can replace them by the data related to the order function. In other words, the user interface and operation instructions of the order function are added. To be noted, however, the method of updating the application can have many variations, and only one embodiment is illustrated here as an example, but those skilled in the art should comprehend that this invention is not limited thereto.

After the updating, as shown in FIG. 3A, the updated sales application has the display function and order function. Besides, the updated sales application is the same as the sales application installed in the mobile communication device 12 of the seller side.

As shown in FIG. 3A, the order function of the sales application is acquired, and besides, the sales bonus counting function can be activated by the activation method of the first or second embodiment or can be added by the updating method of the third embodiment. In detail, when the mobile communication device 12 of the seller side helps the customer purchase the product by the order function of the sales application, the memory module 133 of the server 13 or the memory unit 121 of the mobile communication device 12 can store the transaction record. When the functional icon 126 of “bonus counting” is pressed, the processing unit 122 can execute the instructions related to the bonus counting function to count the bonus amount from the transaction record. In other embodiments, the bonus amount may be counted by the server 13 and then sent to the mobile communication device 12, and then the processing unit 122 executes the instructions displaying the bonus amount.

Moreover, when the customer is transformed into the new seller and obtains the order function by the above-mentioned activation or update method, the customer needs to send the validation data, which is the identity data of the introducer (original seller). The memory module 133 of the server 13 can, on the basis of the stored identity data of the original seller, connect the data of the joiner (transformed into the new seller from the customer) who is convinced by the original seller with the data of the original seller to provide the reference of the bonus counting. Hence, when the new seller markets a product to other customers, the sent order data will be additionally converted into the order success data by the server, for example, to be connected to the original seller, and the bonus counting base of the original seller will be increased thereby. Physically, for example, when the new seller markets a single product, the bonus counting base of the original seller will be increased by one third product.

A mobile communication device is also disclosed in this invention, which can be applied to the sales application system and the method of activating the order function of the application of the above embodiment. The mobile communication device can execute the instructions to have the following operations of: receiving an input by the mobile communication device to send a request data of activating the order function; sending a validation data by the mobile communication device; receiving an authorization data by the mobile communication device; and activating the order function of the application according to the authorization data.

A server is also disclosed in this invention, which can be applied to the sales application system and the method of activating the order function of the application of the above embodiment. The server is connected with a mobile communication device and includes a receiving module and a transmitting module. The receiving module receives a request data of activating the order function and a validation data sent by the mobile communication device. The transmitting module sends an authorization data to the mobile communication device according to the validation data, and the mobile communication device activates an order function of an application according to the authorization data.

A mobile communication device is also disclosed in this invention, which can be applied to the sales application system and the method of updating the application of the above embodiment. The mobile communication device can execute the instructions to have the following operations of: receiving an input by the mobile communication device to send a request data of updating the application; sending a validation data by the mobile communication device; receiving an updating data corresponding to the application by the mobile communication device; and updating the application according to the updating data, wherein the updated application has the display function and an order function.

A server is also disclosed in this invention, which can be applied to the sales application system and the method of updating the application of the above embodiment. The server is connected with a mobile communication device and includes a receiving module and a transmitting module. The receiving module receives a request data of updating the application and a validation data sent by the mobile communication device. The transmitting module sends an updating data to the mobile communication device according to the validation data, and the mobile communication device updates the application according to the updating data, wherein the updated application has the display function and an order function.

The structures of the mobile communication devices and servers disclosed above with the connection relation with other elements can be comprehended by referring to the mobile communication device 11, 12 and the server 13 of the above embodiments, so the related illustration is omitted here for conciseness.

Summarily, in the method of activating the order function of the application and the method of updating the application of the invention, the application of the customer side has the display function instead of other functions of the non-customer side, so that the user of the customer side can intuitively operate the display function and won't be affected by the interfaces of other functions. Besides, the customer side also has no chance to directly purchase products, and therefore the company can totally handle the performance and bonus of the seller. Moreover, when the customer side hopes to be transformed into the seller side, the order function of the application just can be activated after the mobile communication device sends the request data of activating the order function and the validation data and the server provides the authorization data. Or, the application just has the order function after the mobile communication device sends the request data of updating the application and the validation data and the server provides the updating data. In other words, when the customer side hopes to be transformed into the seller side, the customer has no need to download an additional application, and the application can provide the function related to the seller side just by the method of activating the application through the authorization or the method of updating the application. Therefore, the aspiration to become a seller can be promoted and the number of the seller can be increased thereby.

Furthermore, after the mobile communication device sends the validation data, the server just can send the authorization data or updating data to the mobile communication device and then the mobile communication device can operate the order function. Since the validation data is the identity data of the original seller, the relationship between the original seller (introducer) and the new seller can be built, so that the order data of the new seller can be connected to the original seller, so as to facilitate the performance and bonus counting of the company.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A mobile communication device including a memory unit and at least one processing unit, wherein the memory unit stores an application which includes a plurality of instructions and has a display function and an inactivated order function, the processing unit is coupled with the memory unit and executes the instructions to have the following operations of:
receiving an input by the mobile communication device to send a request data of activating the order function;
sending a validation data by the mobile communication device;
receiving an authorization data by the mobile communication device; and
activating the order function of the application according to the authorization data.

2. The mobile communication device as recited in claim 1, wherein the validation data is an identity data of a seller.

3. The mobile communication device as recited in claim 2, wherein the seller has another mobile communication device which is equipped with same application where the order function is activated.

4. The mobile communication device as recited in claim 3, wherein the application has an inactivated sales bonus counting function, and the processing unit executes the instructions to have the following operation of:
activating the sales bonus counting function according to the authorization data.

5. The mobile communication device as recited in claim 1, wherein the application has an inactivated sales bonus counting function, and the processing unit executes the instructions to have the following operation of:
activating the sales bonus counting function according to the authorization data.

6. A server applied to activating an order function of an application and connected with a mobile communication device, comprising:
a receiving module receiving a request data of activating the order function and a validation data sent by the mobile communication device; and
a transmitting module sending an authorization data to the mobile communication device according to the validation data, wherein the mobile communication device activates the order function of the application according to the authorization data.

7. The server as recited in claim 6, wherein the validation data is an identity data of a seller.

8. The server as recited in claim 6, wherein the transmitting module sends a validation request data to the mobile communication device according to the request data of activating the order function, and the mobile communication device reacts to the validation request data to send the validation data.

9. A mobile communication device including a memory unit and at least one processing unit, wherein the memory unit stores an application which includes a plurality of instructions and has a display function, the processing unit is coupled with the memory unit and executes the instructions to have the following operations of:
receiving an input by the mobile communication device to send a request data of updating the application;
sending a validation data by the mobile communication device;
receiving an updating data corresponding to the application by the mobile communication device; and
updating the application according to the updating data, the updated application having the display function and an order function.

10. The mobile communication device as recited in claim 9, wherein the validation data is an identity data of a seller.

11. The mobile communication device as recited in claim 10, wherein the seller has another mobile communication device which is equipped with the updated application.

12. The mobile communication device as recited in claim 11, wherein the updated application further has a sales bonus counting function.

13. The mobile communication device as recited in claim 9, wherein the updated application further has a sales bonus counting function.
